(19) United States
(12) Patent Application Publication
(10) Pub. No.: US 2007/0157926 A1
(43) Pub. Date: Jul. 12, 2007

(54) Heat-retaining lifesaving appliance

(76) Inventor: Mingchen Shang, Dalian (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/410,379

(22) Filed: Apr. 25, 2006

(30) Foreign Application Priority Data
Jan. 10, 2006 (CN) 200620088939.9

(51) Int. Cl. A62B 17/04; B63C 11/02; A62B 17/00

(52) U.S. Cl. 128/201.27; 128/201.22; 128/201.29

(57) ABSTRACT

The present invention relates to assistance and salvage at sea, in particular, to a heat-retaining lifesaving appliance. A heat-retaining lifesaving appliance is provided. It comprises a spherical helmet, a life buoy and a heat-retaining sack body which are integrally sealed. The heat-retaining sack body comprises an external surface layer and an internal layer. A waterproof zip is provided on the heat-retaining sack body and the spherical helmet, respectively, and an air inflation spout is provided on the heat-retaining sack body and the life buoy, respectively. The life buoy is provided between the spherical helmet and the heat-retaining sack body, and the spherical helmet is provided thereon with a sight glass and a breathing cap. According to the present invention, Individuals can save themselves rapidly when a disaster happens, and the area of dissipation is decreased. An automatic distress-call signal generator and a red indicating lamp are provided on the spherical helmet to facilitate the marine search and rescue. Thus the present invention is especially suitable for use by aged people and children.

### BACKGROUND OF THE INVENTION

1. Field of the Invention

The present invention relates to a field of assistance and salvage on the sea, in particular, to a heat-retaining lifesaving appliance.

2. Description of the Related Art

At present, ships are usually equipped with lifesaving devices, such as life buoys and life jackets for use by individuals, or life rafts and lifeboats for use by more than one person. The above lifesaving devices have the following disadvantages:

(1) The life buoy or life jacket used by individuals can only prevent a person who falls into water from sinking, without insulating the person from the cold water which can freeze the person to death if the time before rescue is too long;

(2) The life raft used by more than one person is difficult to be equipped onto a small ship. In addition, the life raft should be operated by a skilled person. Thus, when a marine disaster happens, the life raft tends to be overturned due to incorrect manipulations in emergency or stormy ocean wave circumstance;

(3) Marine search and rescue is difficult because the above lifesaving devices are usually moved far away from the disaster place by the storm and wave at ocean.

### SUMMARY OF INVENTION

The present invention provides a heat-retaining lifesaving appliance which overcomes the disadvantages of the conventional life buoys and life jackets, such as a rescuee is immersed directly into cold water or is suffocated, to enable one person can rapidly operate the heat-retaining lifesaving appliance of the present invention to save himself or herself.

In order to achieve the above objects of the present application, a heat-retaining lifesaving appliance is provided. It comprises a spherical helmet, a life buoy and a heat-retaining sack body which are integrally sealed. The heat-retaining sack body comprises an external surface layer and an internal layer. A waterproof zip is provided on the heat-retaining sack body and the spherical helmet, respectively, and an air inflation spout is provided on the heat-retaining sack body and the life buoy, respectively. The life buoy is provided between the spherical helmet and the heat-retaining sack body, and the spherical helmet is provided thereon with a sight glass and a breathing cap.

In the heat-retaining lifesaving appliance, the breathing cap comprises an indicating lamp cover, a breathing tube and an air inlet. The air inlet is provided with a one-way valve comprising two ball floats, and the breathing tube is connected to a breathing nozzle.

In the heat-retaining lifesaving appliance, the spherical helmet is provided therein with a distress-call signal generator, a breathing nozzle connected to the breathing cap, and a discharging valve for discharging expiration.

In the heat-retaining lifesaving appliance, the heat-retaining sack body is cylindrical or in a shape of one-piece garment.

In the heat-retaining lifesaving appliance, the air inflation spout comprises an internal air inflation spout and an external air inflation spout.

Furthermore, the external surface layer and internal layer of the lifesaving appliance are made of bonded waterproof cloth, with air inflated therebetween. The sight glass is made of Perspex. The breathing cap has a function of providing fresh air for users, and the expiration is discharged through the discharging valve. The breathing cap is made of PVC (polyvinyl chloride) and is provided at the top end thereof with a red indicating lamp cover which is made of Perspex. The one-way valve that comprises plastic ball floats is provided in the two air inlets of the breathing cap. The breathing tube is made of rubber and the breathing nozzle for breath is made of plastic rubber.

When in use, a valve of an air inflation steel cylinder which is connected to the air inflation spout is firstly opened, or a manual air inflation apparatus can also be used. Then the external surface layer, the internal layer and the life buoy are inflated. The steel cylinder is thrown away when the heat-retaining sack body is completely inflated. Then the user puts on the heat-retaining lifesaving appliance with his back toward the waterproof zip, steps into the appliance and squats himself down. Subsequently, the zip on the chest and the helmet is zipped on. When the zip is zipped on completely, two metal pieces at the end of the zip come into contact with each other, meanwhile, the distress-call signal generator and the red indicating lamp are turned on synchronously. Then the user can hold the breathing spout in mouth and jump into the sea water.

In the case of using a heat-retaining lifesaving appliance having a sack body in a shape of one-piece garment, the user can stand astraddle at the middle of the life buoy and inflate the appliance with an air inflation steel cylinder. The steel cylinder is thrown away when the heat-retaining sack body is completely inflated. Then the user zips on the zip on the chest and the helmet, holds the breathing spout in mouth and jumps into the sea water.

The user can also perform inflation through the internal air inflation spout.

The heat-retaining lifesaving appliance of the present invention has the following advantages:

(1) Individuals can save themselves rapidly when a disaster happens;

(2) The rescuee does not contact with water directly. In addition, an air isolation layer is present and the person in the appliance is in a squatting posture. Thus the area of dissipation is decreased;

(3) The automatic distress-call signal generator and the red indicating lamp on the spherical helmet facilitate the marine search and rescue. Thus the present invention is especially suitable for use by aged people and children.

### BRIEF DESCRIPTION OF THE DRAWINGS

The present invention will be described in detail with reference to embodiments and attached drawings.

FIG. 1 is a front sectional view showing a cylindrical sack body according to the present invention;

FIG. 2 is a front sectional view showing a sack body in a shape of one-piece garment according to the present invention;

FIG. 3 is a front view showing a cylindrical sack body according to the present invention;

FIG. 4 is a front view showing a sack body in a shape of one-piece garment according to the present invention;

FIG. 5 is a schematic view of a breathing cap according to the present invention.

### DETAILED DESCRIPTION OF THE PREFERRED EMBODIMENTS

The contents described in the description such as a detailed construction and element are provided to assist a comprehensive understanding of the embodiments of the invention. However, the present invention is not limited to these embodiments. A person skilled in the art will recognize that various changes and modifications of the embodiments described herein can be made without departing from the scope and spirit of the invention. Also, like reference numbers denotes like elements throughout the specification.

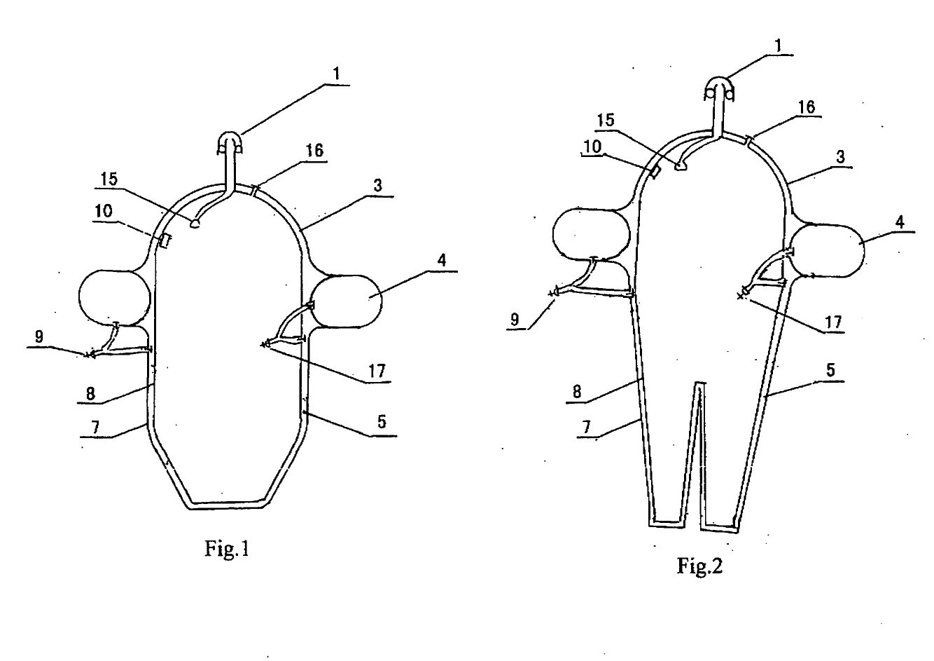

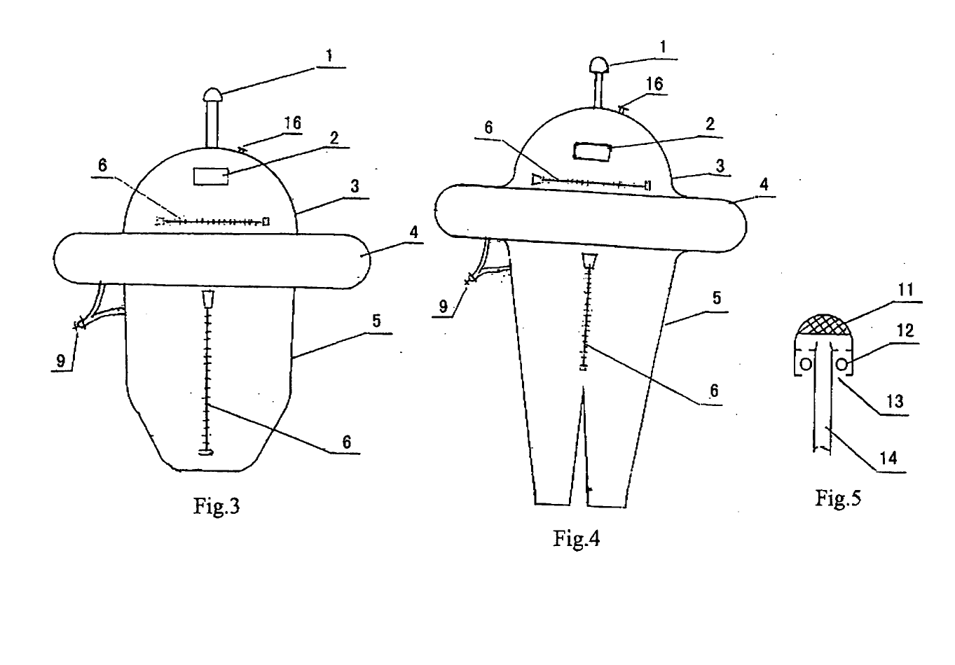

Embodiments of the invention will be described in detail with reference to the drawings. As shown in FIGS. 1-4, a heat-retaining lifesaving appliance is provided. The lifesaving appliance comprises a spherical helmet 3, a life buoy 4 and a heat-retaining sack body 5, which are integrally sealed. The heat-retaining sack body 5 which comprises an external surface layer 7 and an internal layer 8 has a cylindrical shape or in a shape of one-piece garment. A waterproof zip 6 is provided on the heat-retaining sack body 5 and the spherical helmet 3, respectively, and an external air inflation spout 9 and an internal air inflation spout 17 are provided on the heat-retaining sack body 5 and the life buoy 4, respectively. The life buoy 4 is provided between the spherical helmet 3 and the heat-retaining sack body 5, and the spherical helmet 3 is provided thereon with a sight glass 2 and a breathing cap 1. The spherical helmet 3 is provided therein with a distress-call signal generator 10, a breathing nozzle 15, and a discharging valve 16. The breathing cap 1 comprises an indicating lamp cover 11, a breathing tube 14 and an air inlet 13. The air inlet 13 is provided with a one-way valve that comprises two ball floats 12, and the breathing tube 14 is connected to a breathing nozzle 15.

The external surface layer 7 and internal layer 8 are made of bonded waterproof cloth, with air inflated therebetween. The sight glass 2 is made of Perspex. The breathing cap 1 has a function of providing fresh air for users, and the expiration is discharged through the discharging valve 16. The breathing cap 1 is made of PVC and provided at the top end thereof with the red indicating lamp cover 11 which is made of Perspex. The one-way valve that comprises plastic ball floats 12 is provided in the two air inlets 13 of the breathing cap. The breathing tube 14 is made of rubber and the breathing nozzle 15 for breath is made of plastic rubber.

When in use, a valve of an air inflation steel cylinder which is connected to the air inflation spout 9 is firstly opened, or a manual air inflation apparatus can also be used. Then the external surface layer 7, the internal layer 8 and the life buoy 4 are inflated. The steel cylinder is thrown away when the heat-retaining sack body is completely inflated. Then the user puts on the heat-retaining lifesaving appliance with his back toward the waterproof zip 6, steps into the appliance and squats himself down. Subsequently, the zip 6 on the chest and the helmet is zipped on. When the zip 6 is zipped on completely, two metal pieces at the end of the zip come into contact with each other, meanwhile, the distress-call signal generator 10 and the red indicating lamp 11 are turned on synchronously. Then the user can hold the breathing spout in mouth and jump into the sea water.

In the case of using a heat-retaining lifesaving appliance having a sack body in a shape of one-piece garment, the user can stand astraddle at the middle of the life buoy 4 and inflate the appliance with an air inflation steel cylinder. The steel cylinder is thrown away when the heat-retaining sack body is completely inflated. Then the user zippes on the zip 6 on the chest and on the helmet, holds the breathing spout 15 in mouth and jumps into the sea water.

The user can also perform inflation through the internal air inflation spout 17.

### EXAMPLE 1

An example will be described for a user having an average stature of 1.8 m. The user is in a squatting posture in the heat-retaining sack and his head is within the spherical helmet 3 which has a radius of 300 mm. The shoulder of the user is located at a position of the life buoy which is in a form of an annulus having a width of 200 mm and an inner diameter of 600 mm. The body of the user below the shoulder is within the heat-retaining sack body 5 under the life buoy. The sack body 5 has an inner diameter of 600 mm and a height of 700 mm. The total height of the heat-retaining sack is 1.2 m, and an air heat-retaining layer of the sack body has a thickness of 50 mm.

The operation of the appliance is as follows. Firstly, an outlet valve of an air inflation steel cylinder is connected to the air inflation spout 9, and then the valve is opened to inflate the heat-retaining lifesaving appliance. The steel cylinder is removed and thrown away when the heat-retaining sack body is completely inflated. A manual air inflation apparatus can also be used. The user puts on the heat-retaining lifesaving appliance from the head with his back toward the waterproof zip 6, squats himself down and steps into the appliance. Subsequently, the zip 6 on the chest and on the helmet is zipped on. When the zip 6 is zipped on completely, two metal pieces at the end of the zip come into contact with each other, at the same time, the distress-call signal generator 10 and the red indicating lamp are turned on. Then the user can hold the breathing spout 15 in mouth, jump into the sea water, and float in the sea waiting for rescue. And the rescuer can take marine search and rescue actions with the aid of the distress-call signal and the indicating lamp.

### EXAMPLE 2

The operation of the lifesaving appliance having a sack body in a shape of one-piece garment is as follows. The user can stand astraddle at the middle of the life buoy 4 and connect an outlet valve of an air inflation steel cylinder to the air inflation spout 9. Then the valve is opened to inflate the heat-retaining lifesaving appliance. The steel cylinder is removed and thrown away when the heat-retaining sack body is completely inflated. A manual air inflation apparatus can also be used. When the user zipped on the zip 6 on the chest and on the helmet, two metal pieces at the end of the zip come into contact with each other, by which the distress-call signal generator 10 and the red indicating lamp are turned on. Then the user can hold the breathing spout 15 in mouth, jump into the sea water, and float in the sea waiting for rescue. And the rescuer can take marine search and rescue actions with the aid of the distress-call signal and the indicating lamp.

Although the present invention are described with reference to a number of embodiments, a person skilled in the art will recognize that various changes and modifications of the embodiments described herein can be made without departing from the scope and spirit of the invention.

1. A heat-retaining lifesaving appliance, comprising a spherical helmet, a life buoy and a heat-retaining sack body which are integrally sealed, the heat-retaining sack body comprising an external surface layer and an internal layer, a waterproof zip being provided on the heat-retaining sack body and the spherical helmet, respectively, an air inflation spout being provided on the heat-retaining sack body and the life buoy, respectively, the life buoy being provided between the spherical helmet and the heat-retaining sack body, and the spherical helmet being provided thereon with a sight glass and a breathing cap.

2. The heat-retaining lifesaving appliance according to claim 1, wherein:
the breathing cap comprises an indicating lamp cover, a breathing tube and an air inlet, the air inlet is provided therein with a one-way valve comprising two ball floats, and the breathing tube is connected to a breathing nozzle.

3. The heat-retaining lifesaving appliance according to claim 1, wherein:
the spherical helmet is provided therein with a distress-call signal generator, a breathing nozzle connected to the breathing cap, and a discharging valve for discharging expiration.

4. The heat-retaining lifesaving appliance according to claim 1, wherein:
the heat-retaining sack body is cylindrical or in a shape of one-piece garment.

5. The heat-retaining lifesaving appliance according to claim 1, wherein:
the air inflation spout comprises an internal air inflation spout and an external air inflation spout.
